(19) United States
(12) Patent Application Publication
(10) Pub. No.: US 2019/0212409 A1
(43) Pub. Date: Jul. 11, 2019

(54) METHODS AND DEVICES FOR ESTIMATING ANGLE INFORMATION FOR WIRELESS COMMUNICATION SYSTEMS

(71) Applicant: HON HAI PRECISION INDUSTRY CO., LTD., New Taipei (TW)

(72) Inventors: WEN-RONG WU, Hsinchu (TW); PEN-YAO LU, Hsinchu (TW)

(21) Appl. No.: 16/244,142

(22) Filed: Jan. 10, 2019

Related U.S. Application Data
(60) Provisional application No. 62/616,046, filed on Jan. 11, 2018.

(51) Int. Cl. G01S 3/50; G01S 3/04

(52) U.S. Cl. CPC G01S 3/50; H04B 7/0413; G01S 3/043

(57) ABSTRACT

A method for estimating angle information for a wireless communication system includes receiving, by a wireless transmit/receive unit (WTRU), a plurality of first training symbols during a first period of time, wherein the plurality of first training symbols is transmitted using a first transmit beamforming vector fixed during the first period of time and received using a first receive beamforming, vector varied during the first period of time; estimating, by the WTRU, a plurality of first channel delay values based on the plurality of first training symbols; estimating, by the WTRU, a plurality of first channel values based on the plurality of first channel delay values; and estimating, by the WTRU, a first angle value of a path of a wireless channel based on the plurality of first channel values.

### CROSS-REFERENCE TO RELATED APPLICATION(S)

The present application claims the benefit of and priority to a provisional U.S. Patent Application Ser. No. 62/616,046 filed Jan. 11, 2018, entitled “JOINTLY CHANNEL AND AOA/ADD ESTIMATION FOR MIMO-OFDM SYSTEMS WITH HYBRID ARRAYS,” Attorney Docket No. US72484 (hereinafter referred to as “US72484 application”). The disclosure of the US application is hereby incorporated fully by reference into the present application.

### FIELD

The present disclosure generally relates to methods and devices for estimating angle information for wireless communication systems.

### BACKGROUND

The information of Angle of Arrival (AoA) and Angle of Departure (AoD) is required in many applications. Recently, millimeter-wave (mmWave) has been considered in the next-generation (e.g., fifth generation (5G) New Radio (NR)) wireless communication system. Since the pathloss in mmWave transmission is severe, reliable communication requires the beamforming technology with the large-scale antenna arrays. To conduct the beamforming, the AoA/AoD information is needed.

The AoA/AoD estimation methods can be divided into two types, pilot-based and blind. Generally, the pilot-based methods are simpler to implement. However, to date, most pilot-based methods are developed for the narrowband channel scenario, for example, the single-path channel. This limits the application of the pilot-based methods, since the channel in practice generally has multipath response. On the other hand, blind methods, such as Multiple Signal Classification (MUSIC) and Estimation of Signal Parameters via Rotational Invariance Technique (ESPRIT) algorithms, can be applied to a multipath channel. However, MUSIC and ESPRIT algorithms may involve complex matrix operations such as Singular Value Decomposition (SVD).

Thus, there is a need in the art for an improved AoA/AoD estimation method for the next generation wireless communication system.

### SUMMARY

The present disclosure is directed to methods and devices for estimating angle information for wireless communication systems.

In one aspect of the present disclosure, a method for estimating angle information for a wireless communication system is provided. The method includes steps of receiving, by a wireless transmit/receive unit (WTRU), a plurality of first training symbols during a first period of time, wherein the plurality of first training symbols is transmitted using a first transmit beamforming vector fixed during the first period of time and received using a first receive beamforming vector varied during the first period of time; estimating, by the WTRU, a plurality of first channel delay values based on the plurality of first training symbols; estimating, by the WTRU, a plurality of first channel values based on the plurality of first channel delay values; and estimating, by the WTRU, a first angle value of a path of a wireless channel based on the plurality of first channel values.

In another aspect of the present disclosure, a Wireless Transmit/Receive Unit (WTRU) including an antenna array and a processor is provided. The antenna array is configured to receive a plurality of first training symbols during a first period of time. The plurality of first training symbols is transmitted using a first transmit beamforming vector fixed during the first period of time and received using a first receive beamforming vector varied during the first period of time. The processor is coupled to the antenna array and configured to estimate a plurality of first channel delay values based on the plurality of first training symbols, estimate a plurality of first channel values based on the plurality of first channel delay values, and estimate a first angle value of a path of a wireless channel based on the plurality of first channel values.

### BRIEF DESCRIPTION OF THE DRAWINGS

Aspects of the exemplary disclosure are best understood from the following detailed description when read with the accompanying figures. Various features are not drawn to scale. Dimensions of various features may be arbitrarily increased or reduced for clarity of discussion.

FIG. 1 is a schematic diagram of a wireless communication system, in accordance with an implementation of the present disclosure.

FIG. 2 is an illustrative example of the Channel Impulse Response (CIR) in different delay times.

FIG. 3 is an illustrative example of the transmission scheme.

FIG. 4 is a diagram illustrating a flowchart of the estimation of AoA/AoD performed at the receiving side, in accordance with an implementation of the present disclosure.

FIG. 5 illustrates a block diagram of a WTRU for wireless communication, in accordance with various aspects of the present application.

### DETAILED DESCRIPTION

The following description contains specific information pertaining to exemplary implementations in the present disclosure. The drawings in the present disclosure and their accompanying detailed description are directed to merely exemplary implementations. However, the present disclosure is not limited to merely these exemplary implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale, and are not intended to correspond to actual relative dimensions.

For the purpose of consistency and ease of understanding, like features are identified (although, in some examples, not shown) by numerals in the example figures. However, the features in different implementations may be differed in other respects, and thus shall not be narrowly confined to what is shown in the figures.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent.

Additionally, for the purposes of explanation and non-limitation, specific details, such as functional entities, techniques, protocols, standard, and the like are set forth for providing an understanding of the described technology. In other examples, detailed description of well-known methods, technologies, system, architectures, and the like are omitted so as not to obscure the description with unnecessary details.

Persons skilled in the art will immediately recognize that any network function(s) or algorithm(s) described in the present disclosure may be implemented by hardware, software or a combination of software and hardware. Described functions may correspond to modules may be software, hardware, firmware, or any combination thereof. The software implementation may comprise computer executable instructions stored on computer readable medium such as memory or other type of storage devices. For example, one or more microprocessors or general purpose computers with communication processing capability may be programmed with corresponding executable instructions and carry out the described network function(s) or algorithm(s). The microprocessors or general purpose computers may be formed of applications specific integrated circuitry (ASIC), programmable logic arrays, and/or using one or more digital signal processor (DSPs). Although some of the example implementations described in this specification are oriented to software installed and executing on computer hardware, nevertheless, alternative example implementations implemented as firmware or as hardware or combination of hardware and software are well within the scope of the present disclosure.

The computer readable medium includes but is not limited to random access memory (RAM), read only memory (ROM), erasable programmable read-only memory (EPROM), electrically erasable programmable read-only memory (EEPROM), flash memory, compact disc read-only memory (CD ROM), magnetic cassettes, magnetic tape, magnetic disk storage, or any other equivalent medium capable of storing computer-readable instructions.

In addition, the terms “system” and “network” herein may be generally interchangeably used. The term “and/or” herein is only an association relationship for describing associated objects, and represents that three relationships may exist, for example, A and/or B may represent that: A exists alone, A and B exist at the same time, and B exists alone. In addition, the character “/” herein generally represents that the former and latter associated objects are in an “or” relationship.

Furthermore, combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims.

In various implementations of the present disclosure, an AoA/AoD estimation method for wireless communication systems (e.g., Multiple Input Multiple Output (MIMO)-Orthogonal Frequency Division Multiplexing (OFDM) systems) with hybrid antenna arrays is provided. According to the present disclosure, the estimation of AoA and/or AoD can be decoupled and conducted with at least two training symbol sets. Thus, the computational complexity is effectively reduced. For each transmission set, the time-domain Channel Impulse Response (CIR) is estimated. Then from the estimated CIR, the AoA and/or AoD estimation is estimated accordingly. Details of the AoA/AoD estimation method are next described.

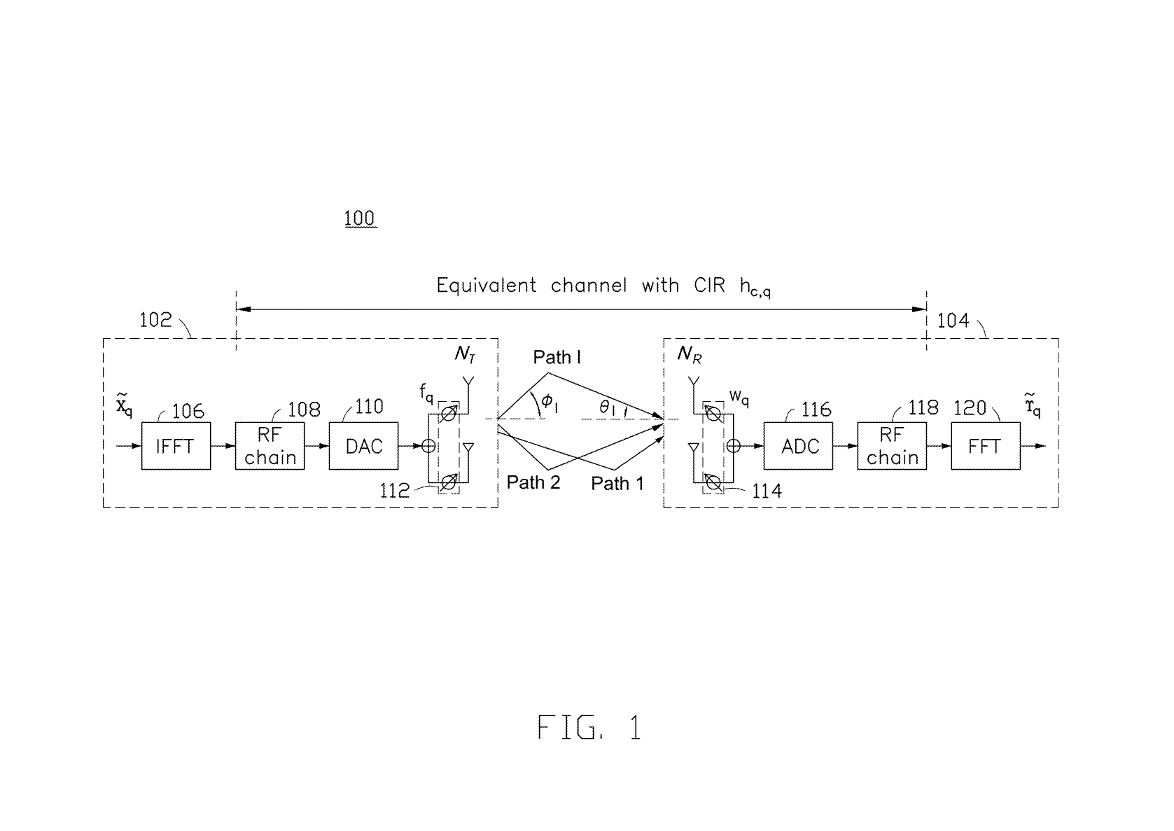

FIG. 1 is a schematic diagram of a wireless communication system 100 (e.g., an OFDM system), in accordance with an implementation of the present disclosure. As shown in FIG. 1, the wireless communication system 100 includes a plurality of Wireless Transmit/Receive Units (WTRUs) 102 and 104. Each of the WTRUs 102 and 104 may be any type of device configured to operate and/or communicate in a wireless environment. For example, the WTRU 102 (or 104) may be configured to transmit (or receive) wireless signals. Each of the WTRUs 102 and 104 may be represented by, for example, a User Equipment (UE), a base station, a personal computer, a wireless sensor, consumer electronics, etc.

In the wireless communication system 100, data is modulated into signals at the WTRU 102, and is then transmitted to the WTRU 104 through a plurality of wireless channels. In a real environment, the wireless channels of the wireless communication system 100 may vary along with the environment and time. When transmitted to the WTRU 104, the received signals at the WTRU 104 may be different from the ones transmitted from the WTRU 102 because the transmitted signals are prone to distortion due to changes and/or interferences of the wireless channels. Thus, at the WTRU 104, in order to recover the received input signals from distortion, the effects of the wireless channels need to be estimated. In some implementations, the channel estimation is implemented using pilot symbols. The pilot symbols may be transmitted in OFDM symbols at certain subcarriers. Because the pilot symbols have known values for both the transmitting side (e.g., the WTRU 102) and the receiving side (e.g., the WTRU 104), the channel can be estimated using the pilot symbols.

In one implementation, the wireless communication system 100 is a MIMO-OFDM system with a Fast Fourier Transform (FFT) size of N over a multipath channel. In the wireless communication system 100, Q consecutive OFDM symbols are transmitted as training symbols for channel estimation. Let the frequency domain OFDM symbol be denoted as \tilde{x}_{q}∈C^{N×1}, where q is an OFDM symbol index ranging from 1 to Q, and C represents the complex domain. At the WTRU 102, the module 106 may transform each \tilde{x}_{q} into a time domain OFDM symbol using N-point Inverse Fast Fourier Transform (IFFT) operations. Then each time domain OFDM symbol is transmitted to the Digital to Analog Converter (DAC) 110 through the Radio Frequency (RF) chain 108. The RF chain 108 may refer to an RF frontend, which may include, for example, but not limited to a phase shifter, a power amplifier, a filter, a local oscillator, and other RF frontend components. The DAC 110 may convert its input into analog signals. The analog signals may be provided to the antenna array 112 for transmission. In one implementation, the antenna array 112 may be a hybrid antenna array, in which a plurality of antenna elements is grouped into multiple analog subarrays, and a single digital signal is received from or sent to each subarray.

According to the exemplary implementation, each frequency domain OFDM symbol \tilde{x}_{q} may have P inserted pilot symbols, denoted as \tilde{x}_{q}^{S}∈C^{P×1}. The superscript S denotes the elements corresponding to the indices of the pilot symbols and the notation will be used in the subsequent discussion. At the receiving side (e.g., the WTRU 104), the time domain OFDM symbol is received by the antenna array 114 and converted into the frequency domain OFDM symbol, denoted as \tilde{r}_{q}∈C^{N×1}, using the Analog to Digital Converter (ADC) 116, the RF chain 118 and the FFT module 120. In one implementation, the antenna array 114 may be a hybrid antenna array. The RF chain 118 may include RF frontend circuitry containing, for example, but not limited to a phase shifter, a power amplifier, a filter and a local oscillator. The FFT module 120 may perform FFT operations to convert its input into the frequency domain OFDM symbol \tilde{r}_{q}.

The number of antennas included in the antenna array 112 and 114 are denoted as NT and N_{R}, respectively. For convenience, in FIG. 1, a Uniformly Linear Array (ULA) with one DAC (e.g., DAC 110)/ADC (e.g., ADC 116) is used at the transmitting/receiving side. It should to be noted that various implementations of the present disclosure can be easily extended to the case of general hybrid array, such as multiple planar arrays with multiple DACs/ADCs. Furthermore, a phase shifter may only adjust the phase of its input signal. It is seen that the amount of the phase shifted can be represented by a weight. With the weights, a beamforming vector is introduced as a column vector which consists of the weights of the phase shifters as the vector elements. The transmit and receive beamforming vector corresponding to the q-th transmission are denoted as f_{q}∈C^{N}^{_{T}}^{×1} and w_{q}∈C^{N}^{_{R}}^{×1}, respectively.

In FIG. 1, the equivalent discrete Channel Impulse Response (CIR) corresponding to the q-th transmission is denoted as h_{c,q}∈C^{N×1}. Assume that the number of path to be L in h_{c,q}. Also, the channel gain and the delay of the 1-th path are denoted as α₁ and k₁, respectively. The AoA and the AoD corresponding to the 1-th path are denoted as θ₁ and θ₁, respectively. Besides, the channel is assumed to be sparse, meaning that the number of paths is much smaller than the FFT size of the OFDM system (e.g., L<<N). Generally, such channel condition can be satisfied in mmWave applications since the pathloss is severe and the transmit/receive signal is highly directional.

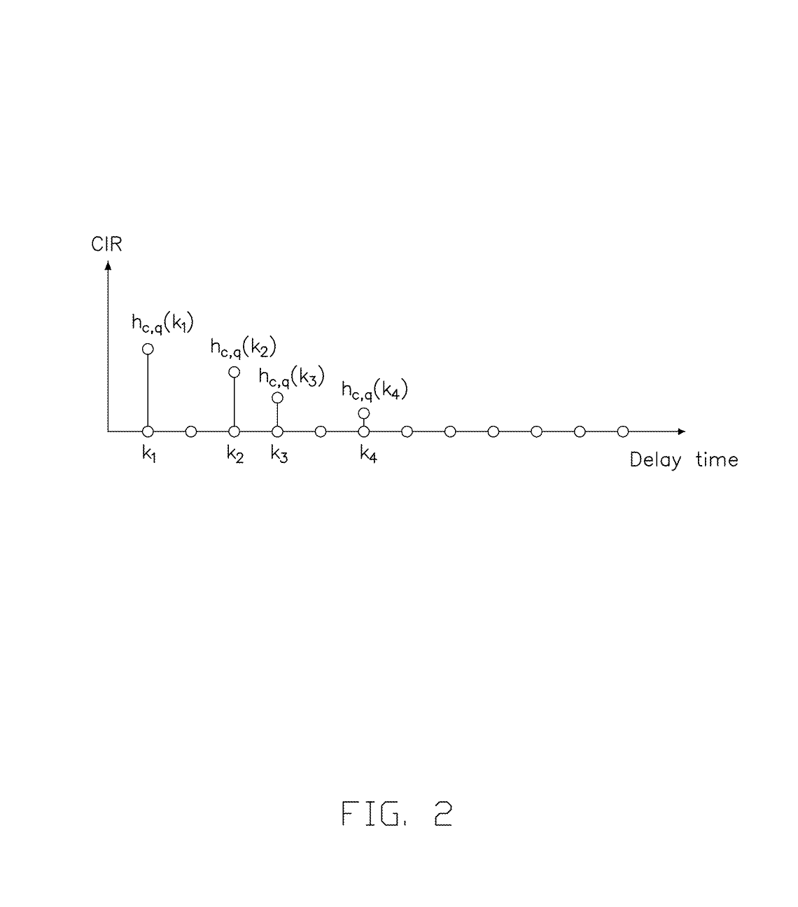

FIG. 2 is an illustrative example of the CIR with L=4 observed at an antenna of the antenna array (e.g., the antenna array 114) with an FFT size of 256. As shown in FIG. 2, for the q-th transmission of the OFDM symbol, the CIRs (channel values) of the four (L) paths include h_{c,q}(k₁), h_{c,q}(k₂), h_{c,q}(k₃) and h_{c,q}(k₄) at delay times k₁, k₂, k₃ and k₄, respectively.

Various implementations on AoA/AoD estimation in a wireless communication system are next described.

A. Training Transmission Scheme

According to exemplary implementations of the present disclosure, the method of AoA/AoD estimation can be pilot-based, so a training transmission is required to transmit the training symbols (or pilot symbols).

To reduce the computational complexity, the AoA and AoD estimations are decoupled. For example, the training transmission is divided into two sets, called Set 1 and 2 with the training transmission Q₁ and Q₂, respectively. Let Set 1 be used for the AoA estimation and Set 2 for the AoD estimation. For simplicity, the number of training symbols in Set 1 and 2 are assumed to be the same and denoted as [symbol] . That is, Q₁=Q₂= [symbol] =Q/2. Accordingly, for each set of training symbols, there are [symbol] received frequency-domain OFDM training symbols, denoted as \tilde{r}_{q}∈C^{N×1}, q=1, 2, . . . , [symbol] . Note that the present disclosure is not limited to the above example. The values of Q₁ and Q₂ may vary and can be different from each other.

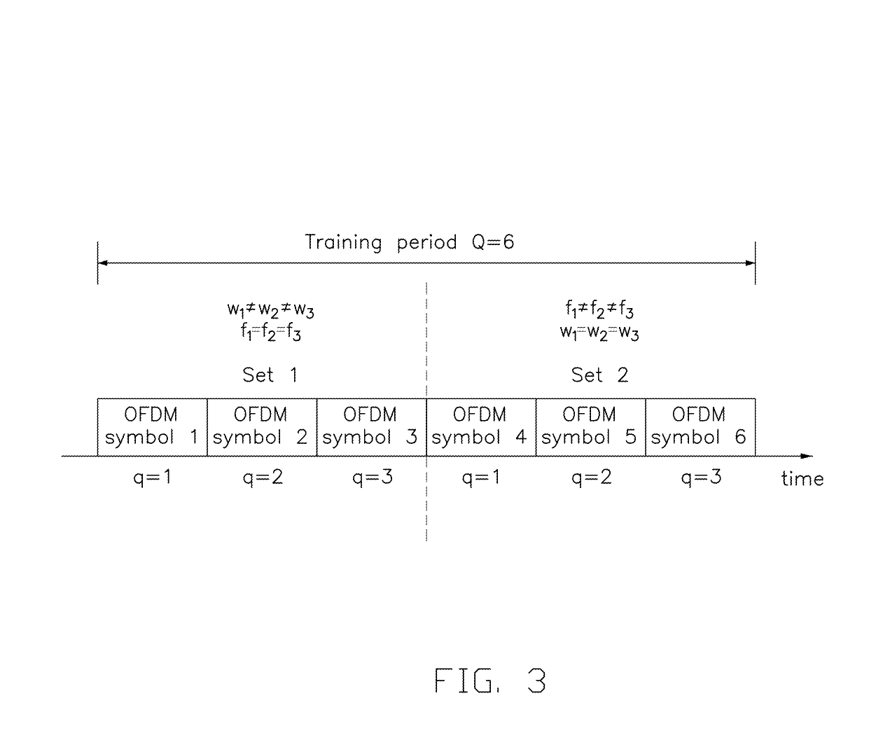

The transmit beaming forming vector and the receive beamforming vector may be arranged as follows. In Set 1 of the training symbols, the transmit beamforming vector, denoted by f_{q}, is fixed and the receive beamforming, vector, denoted by w_{q}, is varied during the period of Set 1 transmission. On the other hand, in Set 2, the transmit beamforming vector f_{q} is varied during the period of Set 2 transmission and the receive beamforming vector w_{q} is fixed during the period of Set 2 transmission. FIG. 3 is an illustrative example of the transmission scheme with [symbol] =3. As shown in FIG. 3, each of Set 1 and Set 2 includes three OFDM symbols (q=1, 2, 3) as the training symbols. During the period of Set 1 transmission, the transmit beamforming vectors f₁, f₂ and f₃ corresponding to the OFDM symbols 1, 2 and 3 are the same (i.e., f₁=f₂ f₃), While the receive beamforming vectors w₁, w₂ and w₃ are linearly independent (e.g., w₁≠w₂≠w₃). On the contrary, during the period of Set 2 transmission, the transmit beamforming vectors f₁, f₂ and f₃ corresponding to the OFDM symbols 4, 5 and 6 are linearly independent (e.g., f₁≠f₂≠f₃), while the receive beamforming vectors w₁, w₂ and w₃ are the same (e.g., w₁=w₂=w₃).

It should be noted that although in FIG. 3 the period of Set 1 transmission is prior to the period of Set 2 transmission, the transmission order of these two transmissions can be exchanged. That is, the period of Set 1 transmission can be prior to or subsequent to the period of Set 2 transmission.

B. Estimation Procedure

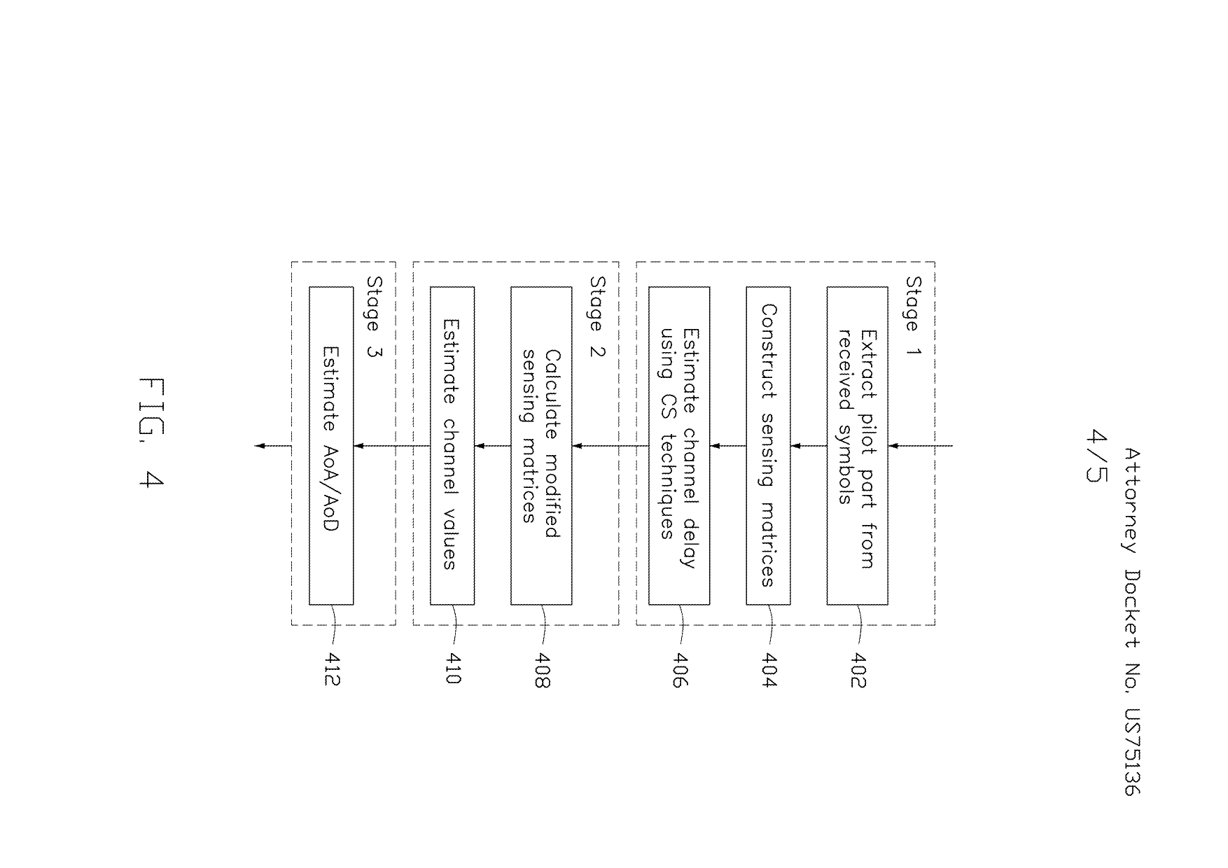

FIG. 4 is a diagram illustrating a flowchart of the estimation of AoA/AoD performed at the receiving side (e.g., the WTRU 104), in accordance with an implementation of the present disclosure. As shown in FIG. 4, the estimation of AoA/AoD can be divided into three stages. The first stage includes actions 402, 404 and 406. The second stage includes actions 408 and 410. The third stage includes action 412. Note that the training transmission scheme for the estimation of AoA, and AoD can be the same. The estimation of AoA, and AoD may only differs in the third stage. Details of each stage are described as follows.

For each training set (e.g., Set 1 and Set 2 shown in FIG. 3), the first stage is to estimate the channel delay values, e.g., k₁, k₂ . . . , k_{L}, based on the received frequency-domain OFDM training symbols \tilde{r}_{q}, q=1, 2, . . . , [symbol] .

As shown FIG. 4, in action 402, the pilot symbols are extracted from the received frequency-domain OFDM training symbols \tilde{r}_{q}. The pilot symbols may be expressed as \tilde{r}_{q}^{S}, q=1, 2, . . . , [symbol] .

In action 404, the sensing matrices for the pilot symbols are constructed. For example, a linear model of \tilde{r}_{q}^{S} can be modeled as

\tilde{r}_{q}^{S}=Φ_{q}h_{c,q}+ñ_{q}^{S} (1)

where Φ_{q} is a sensing matrix containing the preconfigured values of the pilot symbols and elements of the Discrete Fourier Transform (DFT) matrix, and ñ_{q}^{S}∈C^{P×1} is the noise vector.

In action 406, the channel path delay values are estimated. Since h_{c,g} is sparse, the estimation of the indices of the nonzero elements of h_{c,q} can be formulated as a Compressive Sensing (CS) problem. That is, the CS techniques can be employed to search the indices of nonzero elements, i.e., the path delay values. Many existing CS algorithms can be used to solve the problem, such as Matching Pursuit (MP) algorithm and Orthogonal Matching Pursuit (OMP) algorithm.

The second stage of the estimation is to estimate the channel values based on the channel delay values. For example, the channel values of the nonzero paths, denoted as h_{c,q}(k₁), h_{c,q}(k₂), . . . , h_{c,q}(k_{L}) given by channel delay values k₁, k₂, . . . , k_{L} are estimated, where h_{c,q}(kᵢ) denotes the kᵢ-th element of h_{c,q}.

As shown in FIG. 4, actions 408 and 410 are included in this stage. In action 408, modified sensing matrices are calculated. For example, a linear model of \tilde{r}_{q}^{S} can be formulated as shown below:

\tilde{r}_{q}^{S}=Φ′_{q}h′_{c,q}+ñ_{q}^{S} (2)

where h′_{c,q}=[h_{c,q}(k₁), h_{c,q}(k₂), . . . ,h_{c,q}(k_{L})]^{T} and the modified sensing matrix Φ′_{q} is obtained from Φ_{q} with the columns corresponding to the zero elements in removed.

Thereafter, in action 410, the channel values are estimated based on formula (2). For example, the estimation of channel values (e.g., CIRs) can be conducted using the Least-Squares (LS) method, which is shown as follows:

$$[ \begin{matrix}{\hat{h}}_{c , q} ( {k}_{1} ) \\ {\hat{h}}_{c , q} ( {k}_{2} ) \\ ⋮ \\ {\hat{h}}_{c , q} ( {k}_{L} )\end{matrix} ] = {( {Φ}_{q}^{′ H} {Φ}_{q}^{′} )}^{- 1} {Φ}_{q}^{′ H} {\tilde{r}}_{q}^{S} \qquad ( 3 )$$

After all CIRs ĥ_{c,q} (kₗ) for l=1, 1, . . . , L and q=1, 2, . . . [symbol] are estimated, the second stage is completed and the procedure enters the third stage.

The third stage is to estimate AoA/AoD based on the channel values. For example, the channel value, h_{c,q}(kₗ), can be expressed as

h_{c,q}(kₗ)=αₗ(w_{q}^{T}aₗ)(f_{q}^{T}bₗ) (4)

where b₁ and a₁ are the transmit and receive steering vectors, respectively. Since the information about the AoA and AoD, θ₁, and φ₁ is embedded in b₁ and a₁ for q=1, 2, . . . , [symbol] , all of the 1-th estimated path responses (channel values) for the Q transmissions may then be collected, i.e., ĥ_{c,q}(k₁), ĥ_{c,q}(k₂), . . . , ĥ_{c,q}(kᵢ) for the angle value estimation (e.g., θₗ, and φ₁ estimation). As mentioned above, in Set 1 (or Set 2), the transmit beamforming vector f_{q} (or w_{q}) is fixed for all Q transmissions. This implies that α₁ and f_{q}^{T}bₗ (or w_{q}^{T}aₗ) can be combined into one unknown parameter, denoted by α′ₗ≡α₁(f_{q}^{T}bₗ) (or α″ₗ≡αₗ)). As a result, the [symbol] independent observations ĥ_{c,1}(kₗ), ĥ_{c,2}(kₗ), . . . , [symbol] (k₁) may be used to estimate the two unknown parameters θₗ and α′ₗ (or φ₁ and α″ₗ) in Set 1 (or Set 2).

In one implementation, the Maximum Likelihood (ML) criterion may be applied for the estimation of AoA or AoD. For example, the ML criterion for the estimation of AoA and AoD may be formulated as follows, respectively,

$$\begin{matrix}\{ {\hat{α}}_{l}^{′} , {\hat{θ}}_{l} \} = arg {min}_{{α}_{i}^{′} , {θ}_{l}} {‖ {\hat{z}}_{l} - {α}_{i}^{′} {W}^{T} {a}_{l} ‖}^{2} & ( 5 ) \\ \{ {\hat{α}}_{l}^{″} , {\hat{φ}}_{l} \} = arg {min}_{{α}_{i}^{″} , {φ}_{l}} {‖ {\hat{z}}_{l} - {α}_{i}^{″} {F}^{T} {b}_{l} ‖}^{2} & ( 6 )\end{matrix}$$

where \hat{z}=[ĥ_{c,1}(kₗ), ĥ_{c,2}(kₗ), . . . , [symbol] (kₗ)]^{T}, W=[w₁, w₂, . . . , w [symbol] ]^{T} and F=[f₁, f₂, . . . , f [symbol] ]^{T}. For low-complexity implementation, formulas (5) and (6) can be solved by some efficient methods, such as the steep descent or Newton's method. Note that the number of unknown parameters in the ML criterion is small and the required number of the transmissions, Q [symbol] , can be made small also.

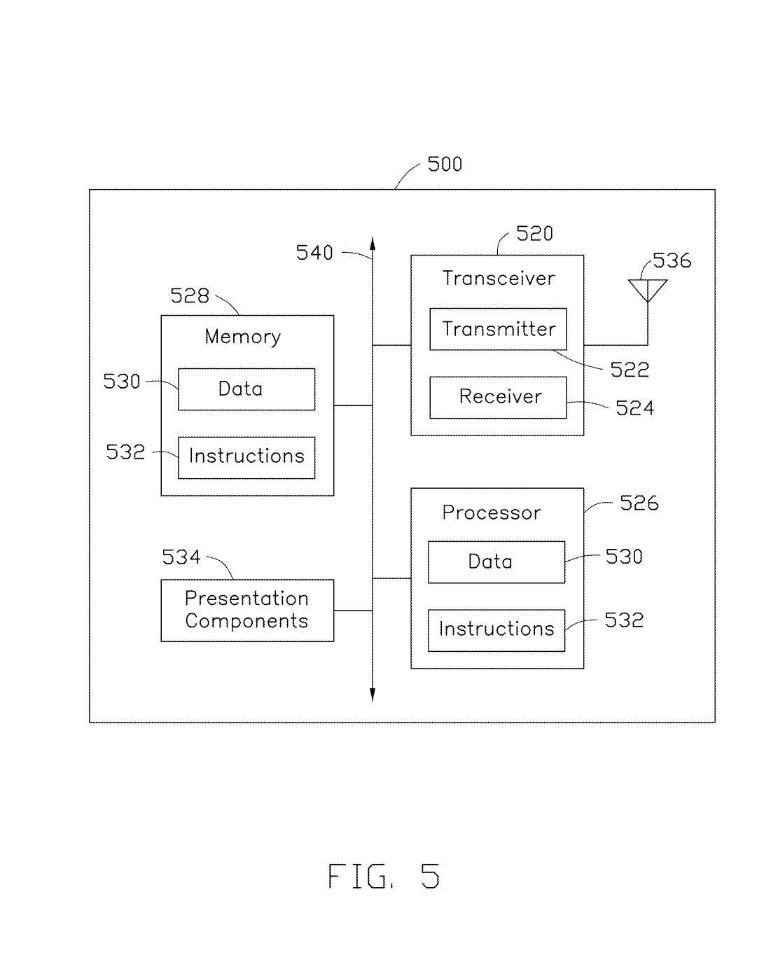

FIG. 5 illustrates a block diagram of a WTRU for wireless communication, in accordance with various aspects of the present application. As shown in FIG. 5, a WTRU 500 may include a transceiver 520, a processor 526, a memory 528, one or more presentation components 534, and at least one antenna (or antenna array) 536. The WTRU 500 may also include an RF spectrum band module, a base station communications module, a network communications module, and a system communications management module, input/output (I/O) ports, I/O components, and power supply (not explicitly shown in FIG. 5). Each of these components may be in communication with each other, directly or indirectly, over one or more buses 540. In one implementation, the WTRU 500 may be a UE or a base station that performs various functions described herein, for example, with reference to FIGS. 1 through 4.

The transceiver 520 having a transmitter 522 (e.g., transmitting/transmission circuitry) and a receiver 524 (e.g., receiving/reception circuitry) may be configured to transmit and/or receive time and/or frequency resource partitioning information. In some implementations, the transceiver 520 may be configured to transmit in different types of subframes and slots including, but not limited to, usable, non-usable and flexibly usable subframes and slot formats. The transceiver 520 may be configured to receive data and control channels.

The WTRU 500 may include a variety of computer-readable media. Computer-readable media can be any available media that can be accessed by the WTRU 500 and include both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 528 may include computer-storage media in the form of volatile and/or non-volatile memory. The memory 528 may be removable, non-removable, or a combination thereof. Exemplary memory includes solid-state memory, hard drives, optical-disc drives, and etc. As illustrated in FIG. 5, The memory 528 may store computer-readable, computer-executable instructions 532 (e.g., software codes) that are configured to, when executed, cause the processor 526 to perform various functions described herein, for example, with reference to FIGS. 1 through 10. Alternatively, the instructions 532 may not be directly executable by the processor 526 but be configured to cause the WTRU 500 (e.g., when compiled and executed) to perform various functions described herein.

The processor 526 (e.g., having processing circuitry) may include an intelligent hardware device, e.g., a central processing unit (CPU), a microcontroller, an ASIC, and etc. The processor 526 may include memory. The processor 526 may process the data 530 and the instructions 532 received from the memory 528, and information through the transceiver 520, the base band communications module, and/or the network communications module. The processor 526 may also process information to be sent to the transceiver 520 for transmission through the antenna 536, to the network communications module for transmission to a core network.

One or more presentation components 534 presents data indications to a person or other device. Exemplary presentation components 534 include a display device, speaker, printing component, vibrating component, and etc.

From the above description, it is manifested that various techniques may be used for implementing the concepts described in the present application without departing from the scope of those concepts. Moreover, while the concepts have been described with specific reference to certain implementations, a person of ordinary skill in the art would recognize that changes may be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A method for estimating angle information for a wireless communication system, comprising:
receiving, by a wireless transmit/receive unit (WTRU), a plurality of first training symbols during a first period of time, wherein the plurality of first training symbols is transmitted using a first transmit beamforming vector fixed during the first period of time and received using a first receive beamforming vector varied during the first period of time;
estimating, by the WTRU, a plurality of first channel delay values based on the plurality of first training symbols;
estimating, by the WTRU, a plurality of first channel values based on the plurality of first channel delay values; and
estimating, by the WTRU, a first angle value of a path of a wireless channel based on the plurality of first channel values.

2. The method according to claim 1, wherein the estimation of the plurality of first channel delay values comprises:
extracting, by the WTRU, a plurality of pilot symbols from the plurality of first training symbols;
constructing, by the WTRU, a plurality of sensing matrices including preconfigured values of the plurality of pilot symbols; and
estimating, by the WTRU, the plurality of first channel delay values using a Compressive Sensing (CS) algorithm based on the plurality of sensing matrices.

3. The method according to claim 2, wherein the estimation of the plurality of first channel values comprises:
estimating, by the WTRU, the plurality of first channel values using a Least-Squares (LS) algorithm based on the plurality of first channel delay values and the plurality of sensing matrices.

4. The method according to claim 1, further comprising:
receiving, by the WTRU, a plurality of second training symbols during a second period of time, wherein the plurality of second training symbols are transmitted using a second transmit beamforming vector varied during the second period of time and received using a second receive beamforming vector fixed during the second period of tune;
estimating, by the WTRU, a plurality of second channel delay values based on the plurality of second training symbols;
estimating, by the WTRU, a plurality of second channel values based on the plurality of second channel delay values; and
estimating, by the WTRU, a second angle value of the path of the wireless channel based on the plurality of second channel values.

5. The method according to claim 4, wherein the first receive beamforming vector is varied for each of the plurality of first training symbols, and the second transmit beamforming vector is varied for each of the plurality of second training symbols.

6. The method according to claim 4, wherein the first angle value represents an Angle of Arrival (AoA) of the path and the second angle value represents an Angle of Departure (AoD) of the path.

7. The method according to claim 4, wherein the first period of time is prior to or subsequent to the second period of time.

8. A wireless transmit/receive unit (WTRU T) comprising:
an antenna array configured to receive a plurality of first training symbols during a first period of time, wherein the plurality of first training symbols is transmitted using a first transmit beamforming vector fixed during the first period of time, and received using a first receive beamforming vector varied during the first period of time; and
a processor coupled to the antenna array and configured to:
estimate a plurality of first channel delay values based on the plurality of first training symbols;
estimate a plurality of first channel values based on the plurality of first channel delay values; and
estimate a first angle value of a path of a wireless channel based on the plurality of first channel values.

9. The WTRU according to claim 8, wherein the processor is further configured to:
extract a plurality of pilot symbols from the plurality of first training symbols;
construct a plurality of sensing matrices including preconfigured values of the plurality of pilot symbols; and
estimate the plurality of first channel delay values using a Compressive Sensing (CS) algorithm based on the plurality of sensing matrices.

10. The WTRU according to claim 9, wherein the processor is further configured to:
estimate the plurality of first channel values using a Least-Squares (LS) algorithm based on the plurality of first channel delay values and the plurality of sensing matrices.

11. The WTRU according to claim 8, wherein the processor is further configured to:
receive a plurality of second training symbols during a second period of time, wherein the plurality of second training symbols are transmitted using a second transmit beamforming, vector varied during the second period of time, and received using a second receive beamforming vector fixed during the first period of time;
estimate a plurality of second channel delay values based on the plurality of second training symbols;
estimate a plurality of second channel values based on the plurality of second channel delay values; and
estimate a second angle value of the path of the wireless channel based on the plurality of second channel values.

12. The WTRU according to claim 11, wherein the first receive beamforming vector is varied for each of the plurality of first training symbols, and the second transmit beamforming vector is varied for each of the plurality of second training symbols.

13. The WTRU according to claim 11, wherein the first angle value represents an Angle of Arrival (AoA) of the path and the second angle value represents an Angle of Departure (AoD) of the path.

14. The WTRU according to claim 11, wherein the first period of time is prior to or subsequent to the second period of time.
